(19) United States
(12) Patent Application Publication
(10) Pub. No.: US 2009/0158553 A1
(43) Pub. Date: Jun. 25, 2009

(54) Hinge for a front bonnet of a motor vehicle

(75) Inventors: Angelo Narducci, Modigliana (IT); Ivan Pavarelli, Maranello (IT); Mauro Del Monte, Modena (IT)

Correspondence Address: DAVIDSON BERQUIST JACKSON & GOWDEY LLP, 4300 WILSON BLVD., 7TH FLOOR, ARLINGTON, VA, 22203, US

(73) Assignee: Ferrari S.p.A., Modena (IT)

(21) Appl. No.: 12/292,024

(22) Filed: Nov. 10, 2008

(30) Foreign Application Priority Data
May 11, 2006 (IT) B02006A000356

(51) Int. Cl. E05D 11/00

(52) U.S. Cl. 16/223

(57) ABSTRACT

A hinge for a front bonnet of a motor vehicle; the hinge is provided with a mobile bracket, which is rigidly connected to the front bonnet, and a fixed bracket, which presents an elongated shape, is hinged to the mobile bracket at a rotation axis of the hinge, and is rigidly connected to a frame of the motor vehicle by means of two fastening screws arranged through two through holes; the rotation axis is arranged at a first end of the fixed bracket, a first through hole presents an elongated shape and is arranged at a second end of the fixed bracket, and a second through hole presents a circular shape and is arranged in an intermediate position between the two ends of the fixed bracket; the first hole is engaged by a first fastening screw which is tightened to the frame with calibrated and limited tightening torque so as to allow a rotation of the fixed bracket about a second fastening screw in case of a collision against the front bonnet at the hinge.

### TECHNICAL FIELD

The present invention relates to a hinge for a front bonnet of a motor vehicle.

### PRIOR ART

Normally, in a motor vehicle, the front bonnet is mounted onto a frame of the motor vehicle itself by means of a pair of hinges arranged laterally on opposite sides of the front bonnet.

Recent international standards have also taken care of protecting the safety of a pedestrian as far as possible in case of frontal collisions against a motor vehicle.

During a frontal collision against a pedestrian, it has been observed that the pedestrian's head tends to violently bang against the front bonnet of the motor vehicle; for such reason, the recent international standards contemplate a limit to the stresses to which the pedestrian's head banging violently against the front bonnet of a motor vehicle is subjected. In order to simulate such situation, recent international standards contemplate hurling a spherical shape test impactor onto the front bonnet of a motor vehicle and measuring the accelerations to which the test impactor is subjected during the collision. Specifically, recent international standards define a synthetic biomedical parameter named “HIC”, which must not exceed a certain threshold value (currently equal to 2000).

A traditional hinge for a front bonnet of a motor vehicle comprises a fixed bracket, which is rigidly connected to a frame of the motor vehicle, and a mobile bracket, which is hinged to the fixed bracket and is rigidly connected to the front bonnet; specifically, the fixed bracket comprises at least two circular shaped through holes, through which screws which are screwed into corresponding threaded holes obtained through the frame are arranged.

It has been observed that by using the traditional hinges of the above-described type, it is very difficult for the front bonnet to present a sufficient pliability at the hinges to limit the accelerations to which the test impactor is subjected during the collision within the limits established by the recent international standards. In other words, the hinges locally stiffen the front bonnet and consequently the front bonnet at the hinges does not present a sufficient pliability to limit the accelerations to which the test impactor is subjected during the collision within the limits established by the recent international standards.

Consequently, various constructive solutions have been suggested to make new types of hinges adapted to give to the front bonnet a sufficient pliability at the hinges to respect the limits established by the recent international standards. Some examples of the new types of hinges are provided in patents US2003010552A1, U.S. Pat. No. 6,415,882B1, US2002046444A1, US2005279550A1.

### DESCRIPTION OF THE INVENTION

It is the object of the present invention to provide a hinge for a front bonnet of a motor vehicle, which hinge is free from the above-described drawbacks and is concurrently easy and cost-effective to manufacture.

According to the present invention, a hinge for a front bonnet of a motor vehicle as claimed in the appended claims is provided.

### BRIEF DESCRIPTION OF THE DRAWINGS

The present invention will now be described with reference to the accompanying drawings which illustrate some non-limitative embodiments thereof, in which:

FIG. 1 diagrammatically shows, in side section and with parts removed for clarity, a front bonnet of a motor vehicle mounted by means of a pair of hinges made according to the present invention;

FIG. 2 shows on a magnified scale a fixed bracket of the hinge in FIG. 1; and

FIG. 3 shows a variant of the fixed bracket in FIG. 1.

### PREFERRED EMBODIMENTS OF THE INVENTION

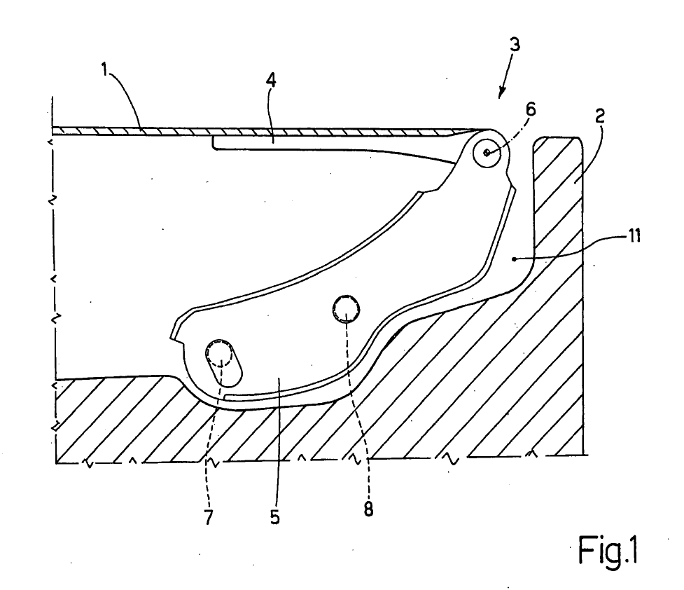

In FIG. 1, numeral 1 indicates a front bonnet of a motor vehicle. Front bonnet 1 is mounted onto a frame 2 of the motor vehicle by means of a pair of hinges 3 (only one of which is shown in FIG. 1) laterally arranged on opposite sides of front bonnet 1.

Each hinge 3 comprises a mobile bracket 4, which is rigidly connected to front bonnet 1, and a fixed bracket 5, which presents an elongated shape and is hinged to fixed hinge 5 to rotate about a rotation axis 6. Fixed bracket 5 is rigidly connected to frame 2 of the motor vehicle by means of two fastening screws 7 and 8 which are arranged through two through holes 9 and 10 obtained through fixed bracket 5 itself; two fastening screws 7 and 8 are fastened into corresponding blank, threaded holes obtained through frame 2 and are preferably provided with corresponding washers (not shown).

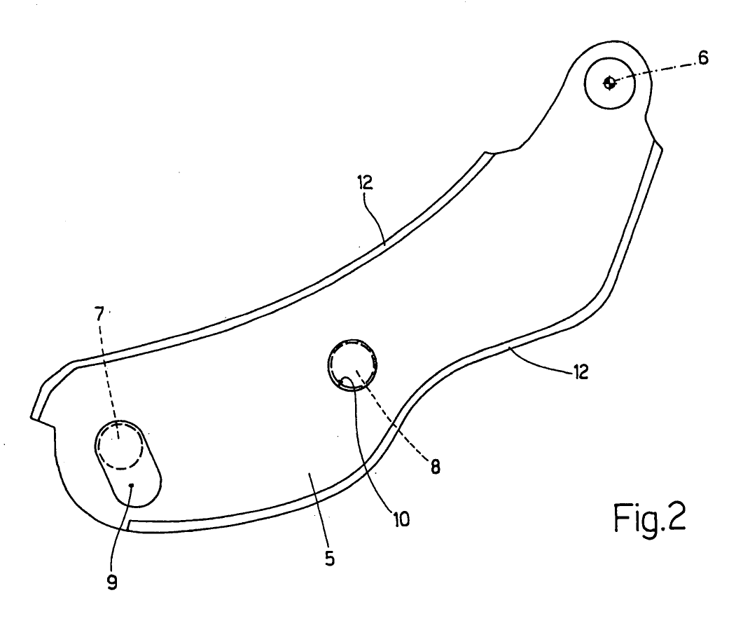

As shown in FIG. 2, rotation axis 6 is arranged at a first end of fixed bracket 5, through hole 9 is arranged at a second end of fixed bracket 5 opposite to the first end, and through hole 10 is arranged in an intermediate position between the two ends of fixed bracket 5.

Through hole 9 is engaged in fastening hole 7 and presents an elongated shape, which has a transversal dimension slightly larger than the diameter of fastening screw 7 and a longitudinal dimension considerably larger than the diameter of fastening screw 7 (indicatively, 2-3 times larger). Through hole 10 is engaged by fastening screw 8 and presents a circular shape having a diameter slightly larger than the diameter of fastening screw 8.

Fastening screws 7 and 8 are tightened to frame 2 of the motor vehicle with corresponding calibrated and limited tightening torques so as to allow a rotation of fixed bracket 5 about fastening screw 8 in case of a collision against front bonnet 1 at hinge 3 and to consequently determine a lowering of the position of rotation axis 6. Specifically, in case of collision against front bonnet 1, the friction force exerted by fastening screws 7 and 8 is not capable of contrasting the rotation of fixed bracket 5 about fastening screw 8 and consequently a lowering of the position of rotation axis 6 is determined. Therefore, in case of collision, front bonnet 1 presents a certain degree of pliability thanks to the lowering of the position of rotation axis 6; such degree of pliability allows to considerably reduce the accelerations to which a body which impacts against front bonnet 1 at hinge 3 is subjected.

It is important to observe that at fixed bracket 5, frame 2 of motor vehicle must present a free area 11 (shown in FIG. 1) to allow fixed bracket 5 itself to rotate about fastening screw 8 in case of a collision against front bonnet 1.

According to a preferred embodiment, fixed bracket 5 comprises two reinforcement ribs 12, which are arranged at opposite side edges of fixed bracket 5 itself.

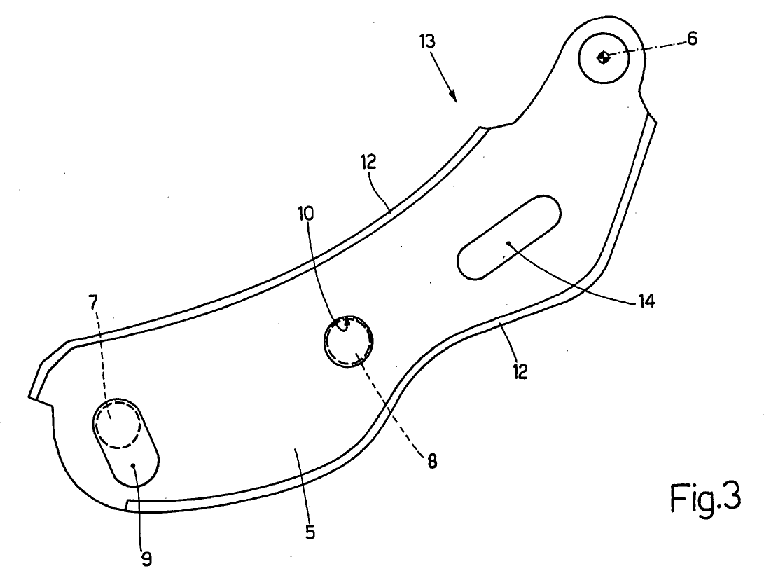

According to different embodiment shown in FIG. 3, fixed bracket 5 comprises a weakened area 13, which is arranged between through hole 10 and rotation axis 6 and is adapted to collapse to consequently determine a further lowering of the position of rotation axis 6. Preferably, weakened area 13 comprises a weakening through hole 14, which is obtained through fixed bracket and presents an elongated shape arranged parallelly to fixed bracket 5; i.e. the largest dimension of weakening through hole 14 is parallel to the largest dimension of fixed bracket 5.

In order to ensure the necessary mechanical strength to fixed bracket 5, the transversal dimension of weakening through hole 14 is smaller than the transversal dimension of the portions of fixed bracket 5 arranged about weakening through hole 14 and on opposite sides of weakening through hole 14 itself.

Theoretical and experimental tests have demonstrated that performing the test established by the recent international standards which contemplates hurling a spherical shape test impactor against front bonnet 1, the synthetic biomedical parameter named “HIC” was lower than the maximum limit of 2000 allowed by the international standards. Furthermore, in the case of the further embodiment shown in FIG. 3 and provided with weakening through hole 14, theoretical simulations have predicted that the synthetic biomedical parameter named “HIC” may be lower than that obtained by the embodiment shown in FIG. 2.

It is thus apparent that above-described hinge 3 is perfectly capable of responding to the requirements of the recent international standards in relation to the safety of a pedestrian in the case of frontal collision. Furthermore, the above-described hinge 3 is simple and cost-effective to manufacture and concurrently presents a high reliability in time.

1) A hinge (3) for a front bonnet (1) of a motor vehicle; the hinge (3) comprising:
a mobile bracket (4), which is rigidly connected to the front bonnet (1); and
a fixed bracket (5), which presents an elongated shape, is hinged to the mobile bracket (4) at a rotation axis (6) of the hinge (3), and is rigidly connected to a frame (2) of the motor vehicle by means of two fastening screws (7, 8) which are arranged through two through holes (9, 10) obtained through the fixed bracket (5) itself; the rotation axis (6) is arranged at a first end of fixed bracket (5), a first through hole (9) is arranged at a second end of the fixed bracket (5) opposite to the first end, and a second through hole (10) is arranged in an intermediate position between the two ends of the fixed bracket (5);
wherein, the first through hole (9) presents an elongated shape and is engaged by a first fastening screw (7);
the second through hole (10) presents a circular shape and is engaged by a second fastening screw (8); and
the first fastening screw (7) is tightened to the frame (2) of the motor vehicle with a calibrated and limited tightening torque so as to allow a rotation of the fixed bracket (5) about the second fastening screw (8) in case of a collision against the front bonnet (1) at the hinge (3) and to consequently determine a lowering of the position of the rotation axis (6).

2) The hinge (3) according to claim 1, wherein the second fastening screw (8) is also tightened to the frame (2) of the motor vehicle with a calibrated and limited tightening torque so as to allow a rotation of the fixed bracket (5) about the second fastening screw (8) in case of a collision against the front bonnet (1) at the hinge (3) and to consequently determine a lowering of the position of the rotation axis (6).

3) The hinge according to claim 1, wherein the fixed bracket (3) comprises two reinforcement ribs (12), which are arranged at opposite side edges of the fixed bracket 5 itself.

4) The hinge (3) according to claim 1, wherein the fixed bracket (5) comprises a weakened area (13), which is arranged between the second through hole (10) and the rotation axis (6) and is adapted to collapse to consequently determine a further lowering of the position of the rotation axis (6).

5) The hinge (3) according to claim 4, wherein the weakened area (13) comprises a third weakening through hole (14) obtained through the fixed bracket (5).

6) The hinge (3) according to claim 5, wherein the third weakening through hole (14) presents an elongated shape arranged parallelly to the fixed bracket (5).

7) The hinge (3) according to claim 6, wherein the transversal dimension of the third weakening hole (14) is smaller than the transversal dimension of the portions of the fixed bracket (5) arranged about the third through hole (14) and on opposite sides of the through hole (14) itself.
